(19) United States
(12) Patent Application Publication
(10) Pub. No.: US 2012/0290107 A1
(43) Pub. Date: Nov. 15, 2012

(54) APPARATUS AND METHOD FOR DISPLAYING STATE DATA OF AN INDUSTRIAL PLANT

(76) Inventors: John Carlson, Fort Worth, TX (US); Philip M. Sherwood, Fort Worth, TX (US)

(21) Appl. No.: 13/106,044

(22) Filed: May 12, 2011

(51) Int. Cl. G06F 15/16; G05B 15/02; G05B 19/05

(52) U.S. Cl. 700/83; 709/203

(57) ABSTRACT

A method for displaying state data of an industrial plant by a server communicating with a client over a network includes, in a first mode, receiving live state data from a data source and sending a portion of the live state data to the client for display into a graphical user interface. The method also includes, in a replay mode, reading stored state data from a data storage, the stored state data being stored at a storage rate, and sending a portion of the stored state data to the client for display into the same or a different graphical user interface at a replay rate, which can be different than the storage rate. The data source can include a programmable logic controller (PLC) and the live state data and the stored state data may represent any combination of sensor data, data derived from sensor data, control output data, control input data, and program state data. The client may include a plurality of clients, in which case the portion of the live state data is sent to one of the plurality of clients and the portion of the stored state data is sent to another of the plurality of clients. The method may further include receiving control input data from the client and sending the control input data to the data source to control the industrial plant.

### BACKGROUND

A programmable logic controller (PLC) is commonly used to control processes in an industrial plant. The PLC communicates with various sensors, e.g., temperature and pressure sensors, and sends controls signals to various actuators, e.g., valves and pumps. The PLC typically reads signals from the sensors, and stores the corresponding values in memory. The PLC generates control outputs and sends them as electrical signals to valves, motors, lights, etc. The PLC contains sets of instructions or program steps for running a particular industrial process, including, for example, on how to respond to various events and how to perform various tasks. These tasks can be initiated by an operator making a selection, typically through a Human Machine Interface (HMI) or graphical user interface that communicates directly or indirectly with the PLC. The PLC will then automate the process from there, automatically making adjustments to outputs in response to sensor inputs and further operator input.

Sensor data and events, such as alarms, can be logged or archived by factory automation programs for later analysis. Traditional systems include archiving of the sensor data and displaying these data as a historical trend chart. Historical trend charts, however, typically differ from the graphical screens or the HMI an operator is used to seeing when running the plant. In addition, historical charts tend to be difficult to read and interpret.

One proposed system has video cameras associated with an event or alarm logger. The operator can pick an event or alarm and the system will find the correct video clip to display. Upon user input, both stored audio-video factory automation content (e.g., a camera recording of a particular location in the plant) for the selected event or time segment and stored audio-video console content (e.g., a camera recording or screen capture of a user console) can be presented. The user can control playback of the audio-video data via a control bar. Drawbacks of such a system are that it requires multiple video cameras and can only play back events in the manner in which the events were recorded.

Other systems having multiple views of an industrial plant which are graphically displayed and viewed have been proposed. The views represent different domains of the industrial plant, e.g., real-time monitoring and operation, configuration, maintenance, and simulation, among others, and may display the same plant at different times (now, past, predicted future). For example, the operator may navigate through a menu tree and see multiple views of the system from the operator's current perspective. Such systems typically tie process recipes, business systems etc. together in a predetermined relationship. These systems can be expensive to implement, because the systems try to anticipate everything that could happen in the plant and determine the relationship between objects to be displayed.

### SUMMARY

A method for displaying state data of an industrial plant by a server communicating with a client over a network includes, in a first mode, receiving live state data from a data source and sending a portion of the live state data to the client for display into a graphical user interface. The method also includes, in a replay mode, reading stored state data from a data storage, the stored state data being stored at a storage rate, and sending a portion of the stored state data to the client for display into the same or a different graphical user interface at a replay rate.

The method may further include selecting any of the first mode and the replay mode in response to a request by the client. The stored state data can be read according to a selection received from the client, which may be any combination of date, time, display interval, and the replay rate. In an embodiment, the data source comprises a programmable logic controller (PLC) and the live state data and the stored state data may represent any combination of sensor data, data derived from sensor data, control output data, control input data, and program state data. Thus, embodiments of the invention can not only log and display sensor data but also process control information, including data associated with the program or process state, such as steps of a multistep process, timers, and counters.

The method may further include causing live state data to be stored to the data storage in response to a request by the client. The method may be performed to monitor any one of a production process and a cleaning process. In some embodiments, the client includes a plurality of clients, in which case the portion of the live state data is sent to one of the plurality of clients and the portion of the stored state data is sent to another of the plurality of clients.

The method may further include receiving control input data from the client and sending the control input data to the data source to control the industrial plant. For example, the control input data can be received in response to user input to the graphical user interface.

The replay rate can be different from the storage rate. For example, live state data may be stored at a periodic sampling interval of 1 second. In replay mode, a user or operator may select to replay the stored state at a replay rate that is faster or slower than the storage rate. For example, the user may choose to replay the stored state data at 10 times or 100 times the storage rate in order to quickly find a particular event that has occurred. In addition, the user may choose to replay the stored data, for example, at half the storage rate to pinpoint the exact time the event occurred and to visualize the state of the process or plant at that time. Alternatively or in addition, the user may pause the replay of stored state data at a particular time.

The graphical user interface typically includes graphical representations of elements of the industrial plant. Such graphical representations can include any combination of static graphical elements and dynamic data representations. The graphical user interface in the first mode can include a first set of graphical representations and the graphical user interface in the replay mode can include the same or a different set of graphical representations.

An apparatus for displaying state data of an industrial plant includes a processor configured to, in a first mode, receive live state data from a data source, and send a portion of the live state data to a client for display into a graphical user interface. The processor is also configured to, in a replay mode, read stored state data from a data storage, the stored state data being stored at a storage rate, and send a portion of the stored state data to a client for display into the same or a different graphical user interface at a replay rate.

The processor can further be configured to receive control data from the client and to send the control data to the data source to control the industrial plant.

A computer program product includes a non-transitory computer readable medium including computer-executable instructions embodied therewith. The instructions, when executed by a processor that communicates with a client over a network, cause the processor to, in a first mode, receive live state data of an industrial plant from a data source, and send a portion of the live state data to the client for display into a graphical user interface. The instructions also cause the processor to, in a replay mode, read stored state data of an industrial plant from a data storage, the stored state data being stored at a storage rate, and send a portion of the stored state data to the client for display into the same or a different graphical user interface at a display rate.

The instructions can further cause the processor to receive control input data from the client and send the control input data to the data source to control the industrial plant.

A method for displaying state data of an industrial plant by a client communicating with a server over a network includes, in a first mode, receiving live state data from a server and displaying the live state data into a graphical user interface. The method also includes, in a replay mode, receiving stored state data from the server, the stored state data being stored at a storage rate, and displaying the stored state data into the same or a different graphical user interface at a replay rate.

The method may further include selecting any of the first mode and the replay mode in response to a user input, and may include sending a selection to the server to cause the stored state data to be read from a data storage according to the selection. The selection can include any combination of date, time, display interval, and the display rate. The live state data and the stored state data can include data from a programmable logic controller (PLC) and the data can represent any combination of sensor data, data derived from sensor data, control output data, control input data, and program state data.

The method may further include sending a request to the server to cause the live state data to be stored to a data storage. The method may be performed to monitor any one of a production process and a cleaning process, and may further include generating a graphical representation of any of the live state data and the stored state data for display. Further yet, the method can include sending control input data to the server to control the industrial plant, and the control input data can be sent in response to user input to the graphical user interface. In replay mode, the client can display the stored state data at a replay rate that is different from the storage rate.

An apparatus for displaying state data of an industrial plant includes a processor configured to, in a first mode, receive live state data from a server and display the live state data into a graphical user interface. The processor is also configured to, in a replay mode, receive stored state data from a server, the stored state data being stored at a storage rate, and display the stored state data into the same or a different graphical user interface at a replay rate.

The processor may further be configured to send control input data to the server to control the industrial plant. The processor can display the stored state data at a replay rate that is different from the storage rate.

A computer program product includes a non-transitory computer readable medium including computer-executable instructions embodied therewith. The instructions, when executed by a processor that communicates with a server over a network, cause the processor to, in a first mode, receive live state data of an industrial plant from a server, and display the live state data into a graphical user interface. The instructions also cause the processor to, in a replay mode, receive stored state data of an industrial plant from a server, the stored state data being stored at a storage rate, and display the stored state data into the same or a different graphical user interface at a display rate.

The instructions can further cause the processor to send control input data to the server to control the industrial plant.

A method for displaying state data of an industrial plant includes receiving live state data of an industrial plant from a data source and storing the live state data to a data storage at a storage rate. Also included are, in a first mode, displaying a portion of the live state data into a graphical user interface, and, in a replay mode, reading the stored state data from the data storage and displaying a portion of the stored state data into the same or a different graphical user interface at a replay rate.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high-level block diagram of a network configuration that illustrates principles of the present approach.

FIG. 2 is a diagram that illustrates data flow in a system according to the principles of the present approach.

FIG. 3 is a diagram that illustrates data flow in a system implemented in a client-server network according to the principles of the present approach.

FIG. 4A is a screen shot of an exemplary configuration dialog box for storing state data from a PLC.

FIG. 4B is a screenshot of the dialog box of FIG. 4A illustrating selection of a common data storage rate.

FIG. 5A is a screen shot of an example graphical screen for display of state data in accordance with the principles of the invention.

FIG. 5B is a screen shot of the graphical screen of FIG. 5A including a control panel overlaid on the graphical screen.

FIG. 6A is a partial view of the diagram of FIG. 2 illustrating display of state data into a graphical display in a first mode.

FIG. 6B is a view of the diagram of FIG. 6A illustrating display of state data into the same or a different graphical display in a replay mode.

### DETAILED DESCRIPTION

The present invention relates to a system and method for using archived data from a programmable logic controller (PLC) or other data sources to drive the display of a human machine interface (HMI) or graphical screen. In particular, the data can be data from an industrial plant, such as data from temperature sensors and valve actuators in a dairy plant, and can include internal program state data of the PLC, including operator control inputs. The HMI or graphics screen displaying archived data can be the same screen that is used to run the plant. Traditional systems include archiving of sensor data and displaying the data as a historical trend chart. The present approach enables the playback of stored data into a graphical user interface to illustrate the states of various components of the plant by providing a graphical view of those states. Instant replay of archived state data may be used, for example, to monitor or trouble-shoot a cleaning process or a production process.

In one embodiment, the system includes a server connected to one or more sources of data, such as a PLC. Connected to the server are one or more local clients. The server receives live data from a data source and/or retrieves stored data and sends the live and/or stored data to one or more clients for display. A client receives the live and/or stored data and displays the data in a graphical screen. Any graphical screen that displays plant data in real time is able to display the archived data. The data can be archived in any time frame desired and can be displayed at any time frame, paused or run at accelerated rates, for example, using a control panel of the graphical user interface. The result is a screen that looks as if it is displaying real time data, but has the ability to freeze the screen and increment at different and variable rates. By redirecting where the data are coming from, e.g., from a PLC or from an archived data source, the screen display does not have to be modified. Furthermore, only the local client screen is affected when running the instant replay display feature. All other screens of the system perform their normal functions, e.g., can display real-time state data of the plant. The local client can display any screen on that local client. Any other client can display real time data or instant replay data for any other time period. Every client could be displaying a different time frame. The real time data are still being archived even when instant replay is running Different portions of the data can be archived at varying rates.

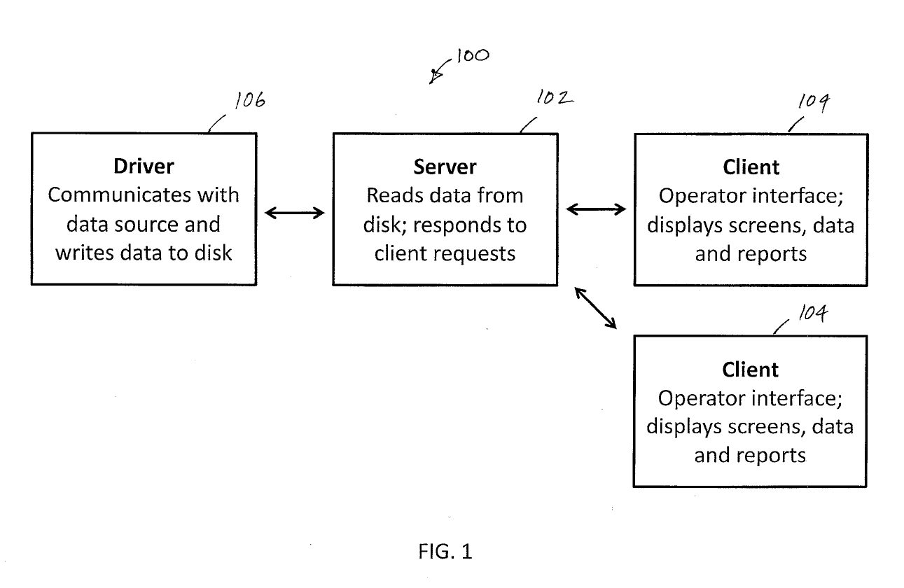

FIG. 1 is a high-level block diagram 100 of a network configuration that illustrates principles of the present approach. In a system for displaying state data from an industrial plant, a server 102 communicates with at least one client 104 and at least one driver 106. Driver 106 communicates with a data source (e.g., a PLC, a sensor, or other factory automation controller), receives live state data from the data source, and writes the live state data to a data storage, e.g. a hard disk. Driver 106 can be a PLC driver specific for a particular brand of PLC. The driver can have one backup instance running on another machine, e.g. on another computer. Server 102 communicates with the clients 104 and the driver 106. Server 102 reads the stored state data and sends the data to clients 104. Typically, server 102 stores all configuration and screen information. The configuration information can include details about which PLC's to communicate with, what data in those PLCs to collect, how often to collect the data from the PLCs, security access descriptions, and other data related to how the system operates. Screen information refers to the electronic description of how to display the state data from the data sources, either live or stored data. Screens include, but are not limited to, static graphical elements as well as dynamic data representations such as numbers, text, graphs, colors, motion, etc. In addition, the server 102 is configured to record dedicated report data (e.g., CIP charts, etc.). The server can have one backup instance running on another machine, e.g. another computer. Each client 104 provides the operator interface or human machine interface (HMI). Multiple instances of client 104 can be running, typically one per computer. Typically, one instance of server 102 is running on a server computer and one or more instances of client 104 are running on local client computers, the computers operatively connected in a network. In one embodiment, server 102, client 104, and driver 106 are implemented on the same computer. Each client 104 talks to the server 102 and receives live state data and/or stored state data for display into a graphical user interface. Client 104 can display live screens, i.e., graphical representations of live state data, instant replay information, i.e., graphical representations of stored state data, and reports, e.g., charts of historical plant data. Live screens displayed by the client allow the operator to control the plant.

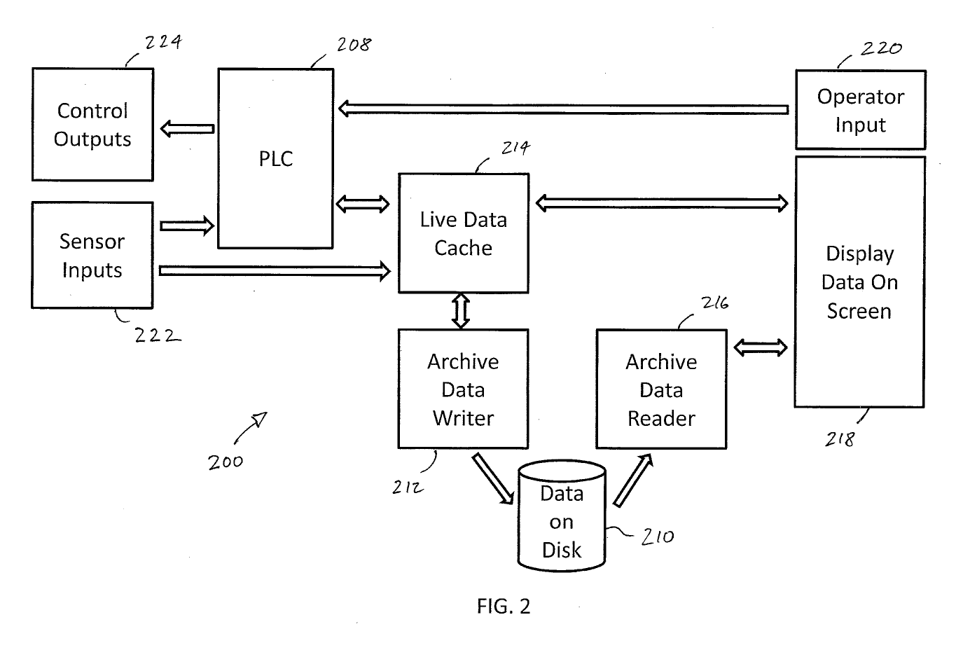

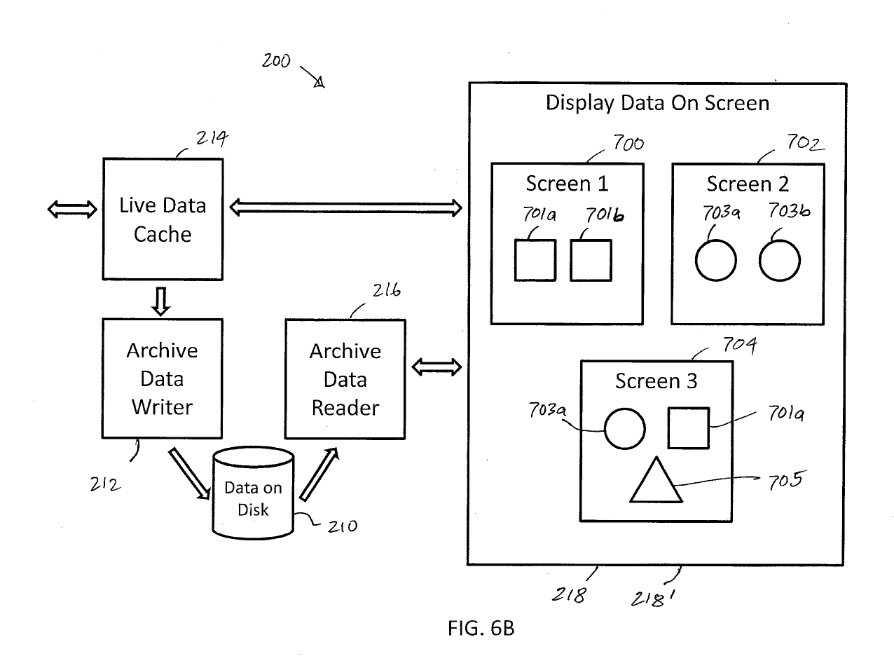

FIG. 2 is a diagram 200 that illustrates data flow in a system according to the principles of the present approach. Live state data of an industrial plant from data sources 208 and 222 are received by live data cache 214 which communicates with and sends the data to archive data writer 212. Archive data writer 212 stores the live state data to a data storage 210 at a storage rate. In a first mode, a portion of the live state data is received from live data cache 214 and displayed into a graphical user interface 218. In a replay mode, archive data reader 216 reads the stored state data from the data storage 210 and sends a portion of the stored state data for display into the graphical user interface 218 at a replay rate. The replay rate, which may be selected by an operator of the system, can be different from the storage rate. The stored state data can also be displayed into a different graphical user interface than the one in which the live data are displayed, as described for example with reference to FIG. 6B below.

As shown in FIG. 2, data source 208 can include a programmable logic controller (PLC). Information associated with PLC 208 includes data from operator input 220, sensor inputs 222, and control outputs 224. In PLC 208, these inputs and outputs may be stored in memory as part of, or in addition to, the PLC internal program state. The live state data and the stored state data may represent any combination of sensor data, data derived from sensor data, control output data, and program state data, which can include data relating to operator inputs.

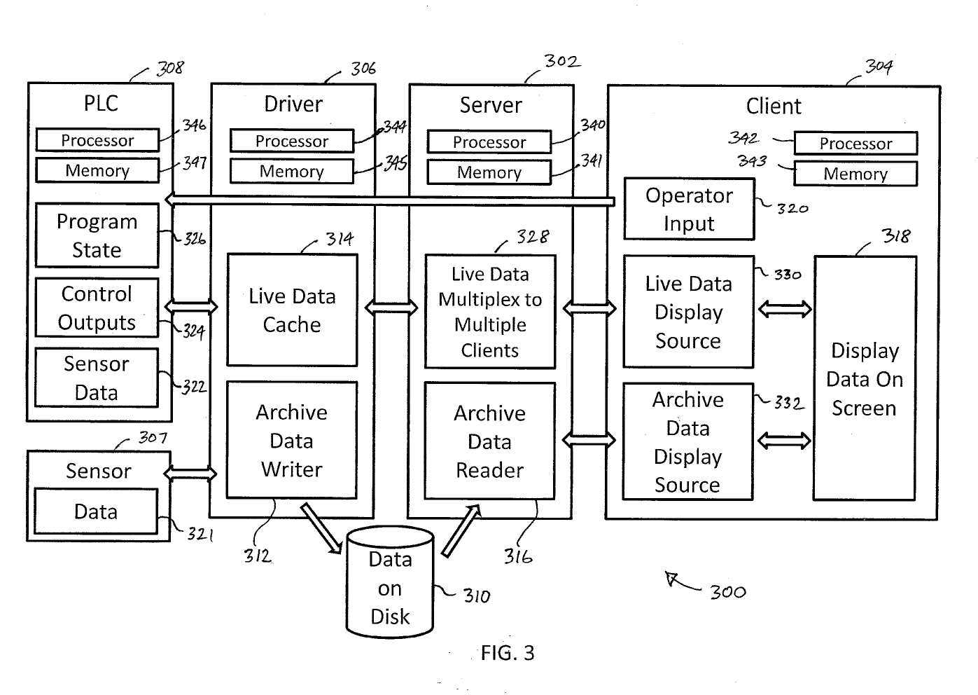

FIG. 3 is a diagram 300 that illustrates data flow in a system implemented in a client-server network according to the principles of the present approach. In a system for displaying state data from an industrial plant, a server 302 communicates with at least one client 304 and at least one driver 306. Driver 306 communicates with a PLC 308, which can be similar to PLC 208 described above, and/or another data source, such as sensor 307. Driver 306 receives live state data from a data source, e.g., PLC 308 and/or sensor 307, and writes the live state data to a data storage 310, e.g., a hard disk drive. Driver 306 is typically specific to a particular brand of PLC or a particular sensor and may have one backup instance running on another machine, e.g. on another computer. Server 302 and driver 306 may or may not be running on the same computer hardware, which may also include data storage 310. In general, data storage 310 could be at any location, e.g., could be local or on a network, at the server or at the client.

As shown in FIG. 3, server 302 can include or be implemented on a processor 340 and a memory 341, client 304 can include or be implemented on a processor 342 and a memory 343, driver 306 can include or be implemented on a processor 344 and a memory 345, and PLC 308 can include a processor 346 and a memory 347. Memory 347 of PLC 308 can be configured to store, among other things, live state data, which can include sensor data, control outputs, control inputs, e.g., operator inputs, and program state data. Memories 341 and 343 can be configured to store, among other things, live state data and/or stored state data. Furthermore, memories 341, 343, 345, and 347 can be configured to store computer-executable instructions for execution by processors 340, 342, 344, and 346, respectively. Instructions in memories 341, 343, 345, and 347 can cause respective processors 304, 342, 344, and 346 to perform various actions as described herein. For example, processor 340 of server 302 can be configured to, in a first mode, receive live state data from PLC 308 and/or sensor 307, and send a portion of the live state data to client 304 for display into a graphical user interface 318. Processor 340 can also be configured to, in a replay mode, read stored state data from data storage 310, the stored state data being stored at a storage rate, and send a portion of the stored state data to client 304 for display into the same or a different graphical user interface at a replay rate. Processor 340 can further be configured to receive control data, e.g., operator input 320, from client 304 and to send the control data to PLC 308 to control the industrial plant. Processor 342 of client 304, for example, can be configured to, in a first mode, receive live state data from server 302 and display the live state data into a graphical user interface 318. Processor 342 can also be configured to, in a replay mode, receive stored state data from server 302, the stored state data being stored at a storage rate, and display the stored state data into the same or a different graphical user interface at a replay rate. The processor 342 may further be configured to send control input data, e.g., operator input 320, to server 302 to control the industrial plant, e.g., via PLC 308.

Driver 306 can include live data cache 314, which may be held in memory 345 to store live state data received from a data sources, such as PLC 308 and sensor 307, and to send live state data from data cache 314 to server 302. Driver 306 can also include archive data writer 312 for writing the live state data received from driver 306 to data storage 310. Archive data writer 314 stores the live state data to data storage 310 at a storage rate. In a first mode, server 302 can receive the live state data from live data cache 314 and send a portion of the live data to client 304 for display into a graphical user interface 318. Server 302 may send live data to multiple clients 304 and can include multiplexer 328 to multiplex the live data to the multiple clients. Multiplexing allows the server to send different sets of data to different clients. In a replay mode, archive data reader 316 of server 302 reads the stored state data from data storage 310 and sends a portion of the stored state data to client 304 for display into graphical user interface 318, in which the live data are displayed, or for display into a different graphical user interface (e.g., a graphical user interface having different graphical representations of elements of the plant or a graphical user interface that is located at a different client). Stored state data are displayed at a replay rate, which can be different from the storage rate.

As shown in FIG. 3, client 304 can include a live data display source 330 to receive the live state data from server 302 and to display the received live data in to user interface 318. Client 304 can also include an archive data display source 332 to, in the replay mode, receive the stored state data and to display the received stored state data into user interface 318 or a different user interface. In the replay mode, the client 304 can display the instant replay or stored state data using the same graphical screens that it would use to display the live data. So instead of the usual approach of just using historical data to create charts, the present approach displays stored state data on the screens to make troubleshooting easier. In other words, the user can switch between live state data and data from a pre-recorded source for display into the same graphics screen.

As described above with reference to PLC 208 of FIG. 2, PLC 306 processes data from various sources, such as operator input 320, sensor data 322, control outputs 324, and internal program state 326. The flow of data from the various sources to the instant replay repository, e.g., data storage 310, will now be described.

a) Operator Selection or Input

At client 304, the operator may initiate an operator input 320, e.g., a control input to control the industrial plant. For example, the operator may initiate input 320 by making a selection on the screen in user interface 318. This triggers a write to the PLC 306. To write, the selection information passes from client 304 to server 302, where it is relayed to the driver 306. The driver 306 then passes the operator input information off to PLC 308, which writes it to PLC memory representing a change in program state 326. Once the memory in the PLC 308 has changed, the driver 306 is notified of the change and records the information to data storage 310.

b) Sensor Data

The PLC 308 reads a signal from a sensor and stores the value in its memory as sensor data 322. The driver 306 is sent notification of the change and records the information to data storage 310. Certain sensors, e.g., checkweighers, can send their data directly to a driver. Sensor 307 can communicate with driver 306 to send sensor data 321 that can then be stored to data storage 310.

c) Control Outputs

The process control program of PLC 308 generates outputs and sends them as electrical signals to valves, motors, lights, etc. The driver 306 is notified of the change in the memory representing the outputs and records the information to data storage 310.

d) Internal Program State

The PLC 308 contains sets of instructions about how to respond to various events and how to perform various tasks. These tasks can be initiated by the operator making a selection. For example, the selection may be communicated to PLC 308 as described above for operator input 320. The PLC will then automate the process from there, automatically making adjustments to outputs in response to sensor inputs and further operator input 320. The present approach can capture these internal states if they are put in the PLC memory. These internal states or values, collectively program state 326, can include intermediate calculations, process step number, timers, counters, and various other values used internally by the PLC program.

Example dialog boxes and graphical screens for use by an operator in accordance with the principles of the invention are described below.

(A) Setup

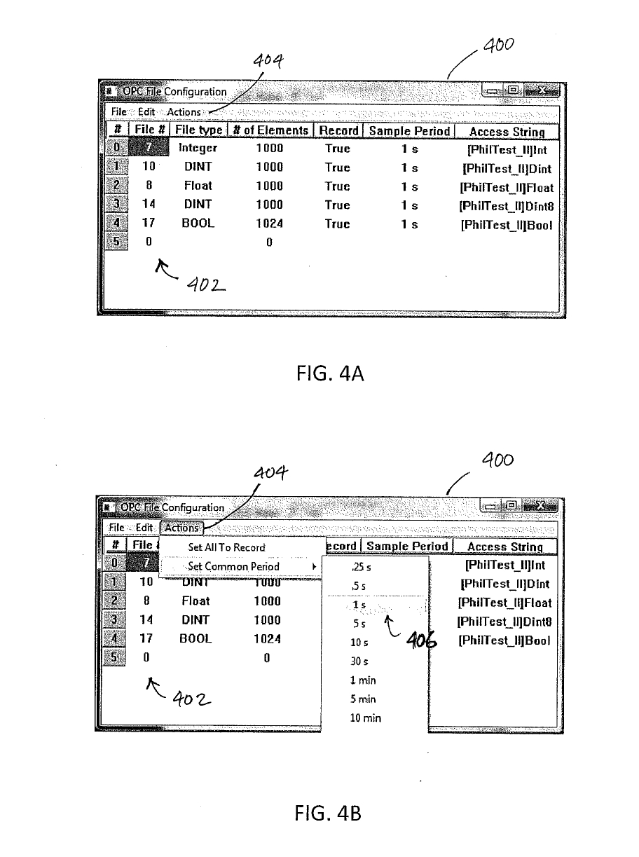

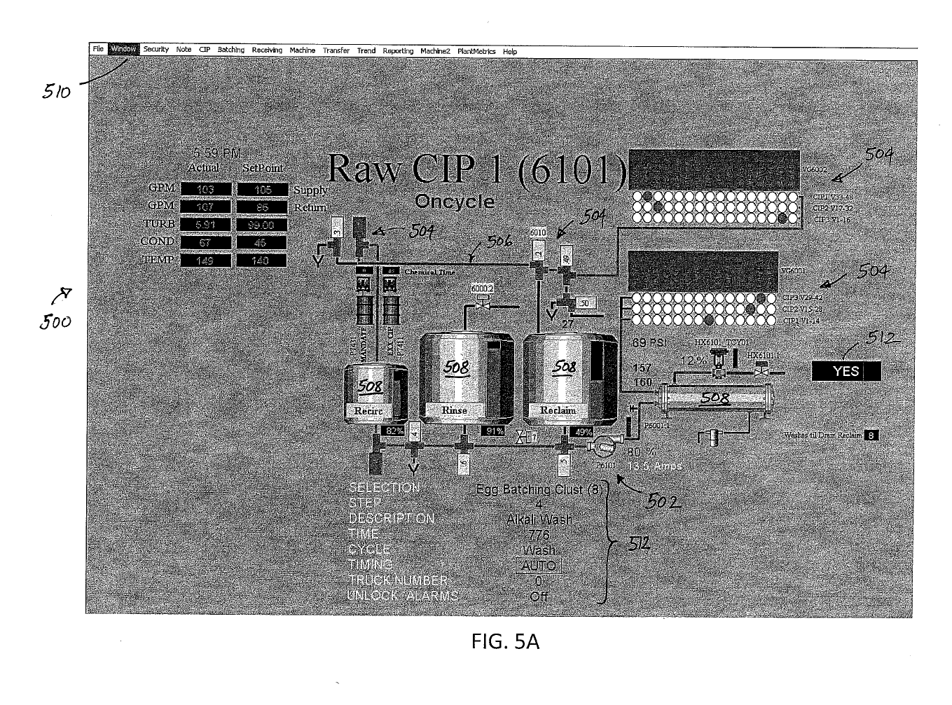

FIG. 4A is a screen shot of an exemplary configuration dialog box for a PLC driver. An operator can enable recording in the PLC register file configuration dialog 400. In the example shown in FIG. 9A, the dialog box is called “OPC File Configuration” with reference to the OPC protocol that can be used to communicate with the processor. Configuration dialog box 400 shows a list of files 402 representing available live state data of the industrial plant that can be recorded or archived (e.g., stored to data storage 310, FIG. 3). Individual register files can be configured for recording or all register files can be set at once using the Actions menu 404. When a particular file is enabled for recording the Record column of the file list 402 of dialog box 400 shows the value “True;” when a files is not enabled for recording the Record column shows “False.” A sampling interval corresponding to a desired storage rate for each data point or file can be selected. FIG. 4B is a screenshot of the dialog box of FIG. 4A illustrating selection of a common data storage rate via the Actions menu 404. A selection of a sampling interval of 1 s is shown at 406, corresponding to a storage rate of 1 sample/second. The system starts archiving the data once the setup parameters are selected and saved.

(B) State Data Display—Instant Replay

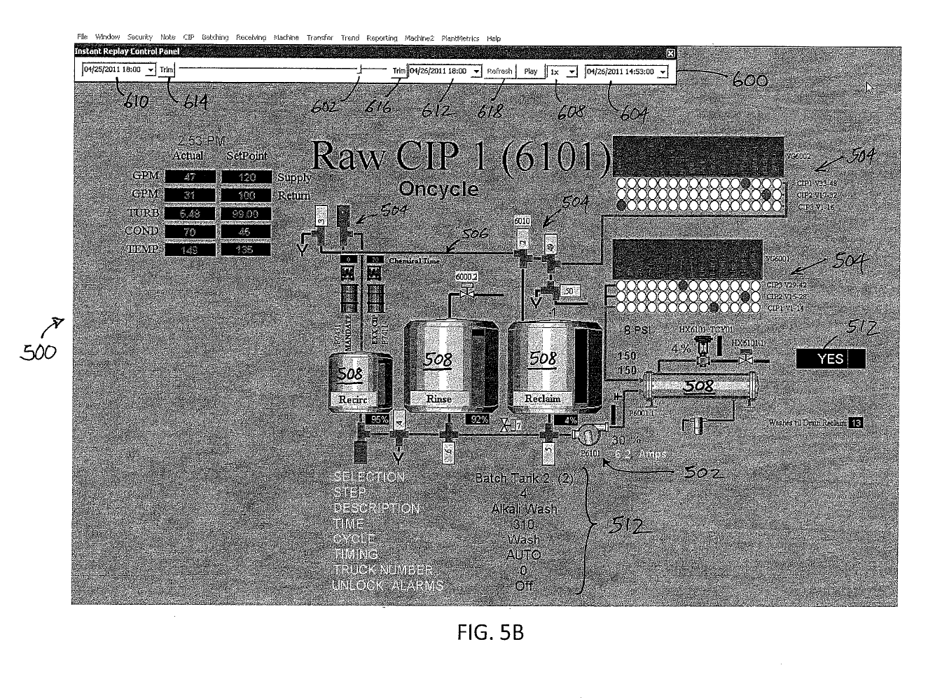

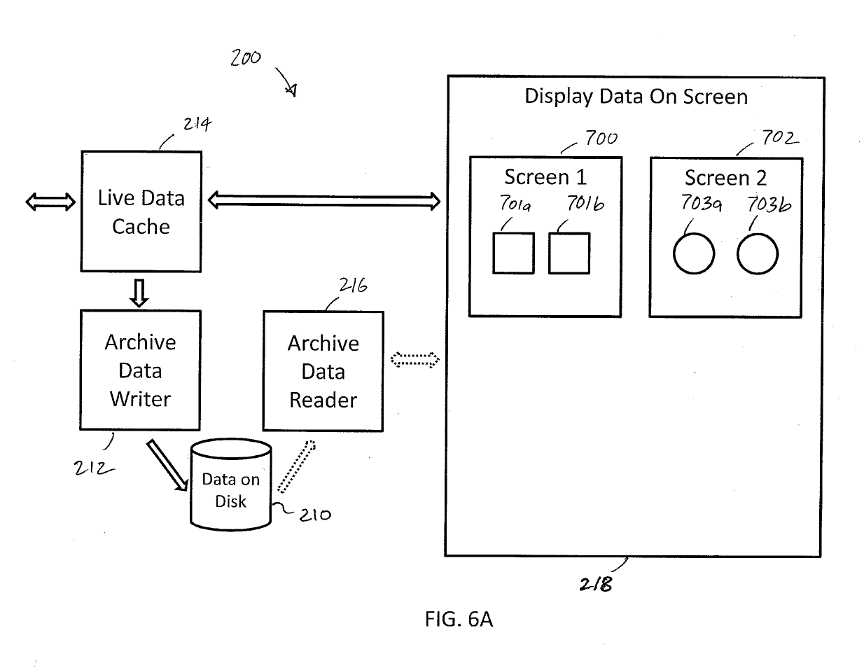

FIG. 5A is a screen shot of an example graphical screen 500 for display of state data in accordance with the principles of the invention. Screen 500 includes graphical representations of various elements of an industrial plant. In the example shown in FIG. 5A, graphical screen 500 is for a Clean in Place (CIP) process and displays graphical representations of elements associated with that process, including pump 502, valves 504, piping 506, and vessels 508, among other elements. Screen 500 also includes a menu bar 510 and buttons 512 to allow the operator to make selections and generate operator inputs to the PLC. The operator can use screen 500 to display live state data, such as during normal plant operation. The operator can also select to enter instant replay mode from the Window menu of the menu bar 510 to display stored state data. The screen 500 does not have to have existed at the time the stored data were recorded. Screens built after the data were recorded will still display the stored data properly.

FIG. 5B is a screen shot of the graphical screen of FIG. 5A including a control panel during replay mode. After the operator selects the instant replay mode from the Window menu, the operator is given a control panel or tool bar 600 shown overlaid on the graphical screen 500. The toolbar 600 is used to set the date range, current display time on the screen, play back, and playback speed. The system defaults to display the past 24 hours, the most likely time frame the operator would be interested in. The system retrieves the stored data. The operator selects a specific time or scrolls through the selected time period and then either pauses the display or selects a replay rate, typically from 0.5× to 100× of the stored data rate, to play back the stored data.

The current display time is specified by moving a slider 602, or by changing the time in a date/time control 604. A Play button 606 automatically advances the current display time at the speed specified by the speed control box 608. The time period is set with the time/date controls 610 and 612 at either end of the slider control. Using Trim buttons 614 and 616 the operator can set the end points to the current display time specified by the slider. A Refresh button 618 is enabled when the date range specified by the end points is not covered by the data currently fetched. The system fetches the data when the Refresh button 618 is pressed. If the operator switches screens while in instant replay mode, the new screen automatically opens at the same point in time as the previous screen. When the operator has finished looking at archived state data, the operator can return to live state data or real-time data display in screen 500 or any other available graphical screen.

One advantage of the invention is that the ability to display, or replay, state data that were previously stored but not displayed. In general, all of the state data available from the data source, e.g., the memory registers in the PLC, are stored or archived. In one embodiment, one file per day per PLC register file is stored to the data storage. In other words, the data are segmented to allow for quick access to the data for reading. Segmenting the data also simplifies testing and eases memory requirements. Although the operator can have the choice of what to archive, it is typically simpler to archive the whole file rather than pick individual or groups of registers. Once all the state data from the data source are stored, the data can be displayed even if the data were not on a screen, i.e. not displayed in a graphical user interface, at the time the data were archived.

FIG. 6A is a partial view of the diagram 200 of FIG. 2 illustrating display of state data into a graphical display in a first mode. Live data cache 214 receives live state data from a data source, e.g., a PLC, and sends the live state data for display into graphical user interface 218. Live data cache 214 also sends live state data to archive writer 212 that stores the data to data storage 210. In the exemplary mode of operation shown in FIG. 6A, archive reader 216 does not read stored state data from data storage 210 and does not send stored state data for display into graphical user interface 218. Graphical user interface 218 includes graphical representations of elements of the industrial plant. Such graphical representations can include any combination of static graphical elements, e.g., a symbol for a vessel or a pump, and dynamic data representations, e.g., a moving color bar indicating tank level. In FIG. 6A, the graphical user interface 218 includes two graphical screens 700 and 702 (Screen 1 and Screen 2). Screen 700 includes graphical representations 701a and 701b, illustrated as squares, and screen 702 includes graphical representations 703a and 703b, illustrated as circles. Graphical representations 701a, 701b, 703a, and 703b represent elements and associated live state data of the industrial plant. The squares 701a, 701a and the circles 703a, 703b illustrate that different sets of graphical representations can be available to display different aspects or portions of the live state data. As shown, screens 700 and 702 exist at the time the live state data are recorded or stored to data storage 210.

FIG. 6B is a view of diagram 200 of FIG. 6A illustrating that, in a replay mode, stored state data can be displayed into the same 218 or a different 218′ graphical user interface. Graphical user interface 218′ differs from 218 (FIG. 6A) because it includes an additional graphical screen 704 (Screen 3) that was created after the state data were recorded. Graphical screen 704 includes graphical representations of elements to display associated state data previously displayed on screens 700 and 702 (circle 703a, square 701a). In addition, screen 704 includes graphical representations of elements and associated state data, previously not displayed on any screen (triangle 705). In replay mode, archive reader 216 reads stored state data from data storage 210 and sends it for display into any of the previously available screens 700 and 702 (Screens 1 and 2), and new screen 704 (Screen 3).

The ability to play back state data previously not displayed is important for several reasons. During replay mode, the operator can select stored data for display in any screen (e.g., 700, 702 and 704, FIG. 6B) that is available in the graphical user interface. This can be accomplished, for example, in the graphical user interface by drawing a link to the stored state data on a screen whereupon the stored state data will be displayed in that screen. Being able to display previously not displayed data can also be very useful when trouble shooting a complex problem. For example, the operator may be able to copy parts of several screens (e.g., 701a and 703a) into an existing or a new screen (e.g., 704) to display the items from the stored data that the operator is interested in. In addition, the operator can also create a completely new graphical screen that has items on it that may be related to the problem and watch how these items relate to each other as the operator plays back the sequence of events captured in the stored state data.

An example is a boiler in an industrial plant that goes off line because of low water. This is an indication of high steam usage. The plant operator uses an embodiment of the present invention to find when the boiler problem occurred. The operator examines every graphical screen that shows steam valves and is able to narrow the problem down to a single large valve. In this case, a new screen is made that shows the valves after the fact and the operator easily finds the problem. For example, the problem could have plagued the plant operator for over a year and seem to be random, usually happening on third shift. However, after examining the graphical screens, the operator is able to discover that the problem is not random at all, but instead directly linked to the performance of a single valve.

As illustrated by the above example, the real power of the present approach is that it allows the plant operator to visualize the state of the plant and its elements in any particular process. Using the instant replay feature of the present approach, the operator need not be an engineer or be familiar with historical charts in order to trouble shoot a problem because the operator can typically use the same graphical screens the operator uses to run the plant to visualize the stored state data. In replay mode, the problem described above is easier to solve because the operator can quickly scroll through the boiler screen to see when the incident happened. Initially, the operator only knows that the incident has occurred the previous night. Once the operator knows the time of the incident, the operator is able to back up the display a little more and then slowly watch the events unfold. In addition, once the operator has an indication of which valve or valves are the problem, the operator is able the go further back in time, find the “random” incidents, and check the correlation between the incidents and the performance of the valve or valves. Without the ability to speed up the trouble shooting process using the instant replay feature of the present approach, finding the cause of the problem would likely take much longer. Without the ability to speed up and to pause replay of the state data, the operator probably would glaze over and miss the occurrence of the valve failure.

It should be noted that functions performed by embodiments that implement aspects of the present invention, may be implemented in whole or in part using some combination of hardware and/or software. It should be further noted that computer-executable instructions and/or computer data that implement aspects of the present invention may be stored in other computer-readable mediums, such as volatile memories, non-volatile memories, flash memories, removable disks, non-removable disks and the like. In addition, it should be noted that various electromagnetic signals, such as wireless signals, electrical signals carried over a wire, optical signals carried over optical fiber and the like, may be encoded to carry computer-executable instructions and/or computer data that implement aspects of the present invention on e.g., a data network.

While this invention has been particularly shown and described with references to example embodiments thereof, it will be understood by those skilled in the art that various changes in form and details may be made therein without departing from the scope of the invention encompassed by the appended claims.

What is claimed is:

1. A method for displaying state data of an industrial plant by a server communicating with a client over a network, the method comprising:
in a first mode, receiving live state data from a data source and sending a portion of the live state data to the client for display into a graphical user interface; and
in a replay mode, reading stored state data from a data storage, the stored state data being stored at a storage rate, and sending a portion of the stored state data to the client for display into the same or a different graphical user interface at a replay rate.

2. The method of claim 1, further comprising selecting any of the first mode and the replay mode in response to a request by the client.

3. The method of claim 1, wherein the stored state data are read according to a selection received from the client.

4. The method of claim 3, wherein the selection comprises any combination of date, time, display interval, and the replay rate.

5. The method of claim 1, wherein the data source comprises a programmable logic controller (PLC).

6. The method of claim 5, wherein the live state data and the stored state data represent any combination of sensor data, data derived from sensor data, control output data, control input data, and program state data.

7. The method of claim 1, further comprising causing live state data to be stored to the data storage in response to a request by the client.

8. The method of claim 1 performed to monitor any one of a production process and a cleaning process.

9. The method of claim 1, wherein the client includes a plurality of clients and wherein the portion of the live state data is sent to one of the plurality of clients and the portion of the stored state data is sent to another of the plurality of clients.

10. The method of claim 1, further comprising receiving control input data from the client and sending the control input data to the data source to control the industrial plant.

11. The method of claim 10, wherein the control input data are received in response to user input to the graphical user interface.

12. The method of claim 1, wherein in the replay rate is different from the storage rate.

13. The method of claim 1, wherein the graphical user interface comprises graphical representations of elements of the industrial plant.

14. The method of claim 13, wherein the graphical representations include any combination of static graphical elements and dynamic data representations.

15. The method of claim 13, wherein the graphical user interface in the first mode includes a first set of graphical representations and the graphical user interface in the replay mode includes the same or a different set of graphical representations.

16. An apparatus for displaying state data of an industrial plant, the apparatus comprising:
a processor configured to:
in a first mode,
receive live state data from a data source, and
send a portion of the live state data to a client for display into a graphical user interface; and
in a replay mode,
read stored state data from a data storage, the stored state data being stored at a storage rate, and
send a portion of the stored state data to a client for display into the same or a different graphical user interface at a replay rate.

17. The apparatus of claim 16, wherein the processor is further configured to receive control input data from the client and to send the control input data to the data source to control the industrial plant.

18. The apparatus of claim 16, wherein the replay rate is different from the storage rate.

19. The apparatus of claim 1, wherein the graphical user interface comprises graphical representations of elements of the industrial plant.

20. The apparatus of claim 19, wherein the graphical representations include any combination of static graphical elements and dynamic data representations.

21. The apparatus of claim 19, wherein the graphical user interface in the first mode includes a first set of graphical representations and the graphical user interface in the replay mode includes the same or a different set of graphical representations.

22. A computer program product comprising:
a non-transitory computer readable medium comprising computer-executable instructions embodied therewith, which, when executed by a processor that communicates with a client over a network, cause the processor to:
in a first mode,
receive live state data of an industrial plant from a data source, and
send a portion of the live state data to the client for display into a graphical user interface; and
in a replay mode,
read stored state data of an industrial plant from a data storage, the stored state data being stored at a storage rate, and
send a portion of the stored state data to the client for display into the same or a different graphical user interface at a display rate.

23. The computer program product of claim 22, wherein the instructions further cause the processor to:
receive control input data from the client; and
send the control input data to the data source to control the industrial plant.

24. A method for displaying state data of an industrial plant by a client communicating with a server over a network, the method comprising:
in a first mode, receiving live state data from a server and displaying the live state data into a graphical user interface; and
in a replay mode, receiving stored state data from the server, the stored state data being stored at a storage rate, and displaying the stored state data into the same or a different graphical user interface at a replay rate.

25. The method of claim 24, further comprising selecting any of the first mode and the replay mode in response to a user input.

26. The method of claim 24, further comprising sending a selection to the server to cause the stored state data to be read from a data storage according to the selection.

27. The method of claim 26, wherein the selection comprises any combination of date, time, display interval, and the display rate.

28. The method of claim 24, wherein the live state data and the stored state data include data from a programmable logic controller (PLC).

29. The method of claim 28, wherein the live state data and the stored state data represent any combination of sensor data, data derived from sensor data, control output data, control input data, and program state data.

30. The method of claim 24, further comprising sending a request to the server to cause the live state data to be stored to a data storage.

31. The method of claim 24 performed to monitor any one of a production process and a cleaning process.

32. The method of claim 24, further comprising generating a graphical representation of any of the live state data and the stored state data for display.

33. The method of claim 24, further comprising sending control input data to the server to control the industrial plant.

34. The method of claim 33, wherein the control input data are sent in response to user input to the graphical user interface.

35. The method of claim 24 wherein in the replay rate is different from the storage rate.

36. The method of claim 24, wherein the graphical user interface comprises graphical representations of elements of the industrial plant.

37. The method of claim 36, wherein the graphical representations include any combination of static graphical elements and dynamic data representations.

38. The method of claim 36, wherein the graphical user interface in the first mode includes a first set of graphical representations and the graphical user interface in the replay mode includes the same or a different set of graphical representations.

39. An apparatus for displaying state data of an industrial plant, the apparatus comprising:
a processor configured to:
in a first mode,
receive live state data from a server; and
display the live state data into a graphical user interface; and
in a replay mode,
receive stored state data from a server, the stored state data being stored at a storage rate; and
display the stored state data into the same or a different graphical user interface at a replay rate.

40. The apparatus of claim 39, wherein the processor is further configured to send control data to the server to control the industrial plant.

41. The apparatus of claim 39, wherein the replay rate is different from the storage rate.

42. The apparatus of claim 39, wherein the graphical user interface comprises graphical representations of elements of the industrial plant.

43. The apparatus of claim 42, wherein the graphical representations include any combination of static graphical elements and dynamic data representations.

44. The apparatus of claim 42, wherein the graphical user interface in the first mode includes a first set of graphical representations and the graphical user interface in the replay mode includes the same or a different set of graphical representations.

45. A computer program product comprising:
a non-transitory computer readable medium comprising computer-executable instructions embodied therewith, which, when executed by a processor that communicates with a server over a network, cause the processor to:
in a first mode,
receive live state data of an industrial plant from a server, and
display the live state data into a graphical user interface; and
in a replay mode,
receive stored state data of an industrial plant from a server, the stored state data being stored at a storage rate, and
display the stored state data into the same or a different graphical user interface at a display rate.

46. The computer program product of claim 45, wherein the instructions further cause the processor to:
send control input data to the server to control the industrial plant.

47. A method for displaying state data of an industrial plant, the method comprising:
receiving live state data of an industrial plant from a data source;
storing the live state data to a data storage at a storage rate;
in a first mode, displaying a portion of the live state data into a graphical user interface; and
in a replay mode, reading the stored state data from the data storage and displaying a portion of the stored state data into the same or a different graphical user interface at a replay rate.

48. The method of claim 47, wherein the replay rate is different from the storage rate.

49. The method of claim 47, wherein the data source comprises a programmable logic controller (PLC).

50. The method of claim 49, wherein the live state data and the stored state data represent any combination of sensor data, data derived from sensor data, control output data, control input data, and program state data.

51. The method of claim 47, wherein the graphical user interface comprises graphical representations of elements of the industrial plant.

52. The method of claim 51, wherein the graphical representations include any combination of static graphical elements and dynamic data representations.

53. The method of claim 51, wherein the graphical user interface in the first mode includes a first set of graphical representations and the graphical user interface in the replay mode includes the same or a different set of graphical representations.
